(19) United States
(12) Patent Application Publication
(10) Pub. No.: US 2018/0118164 A1
(43) Pub. Date: May 3, 2018

(54) Customizable Vehicle Security System

(71) Applicant: Uber Technologies, Inc., San Francisco, CA (US)

(72) Inventor: Matthew Shaw Wood, Pittsburgh, PA (US)

(21) Appl. No.: 15/799,469

(22) Filed: Oct. 31, 2017

(30) Foreign Application Priority Data
Oct. 31, 2016 (AU) 2016250506

(51) Int. Cl. B60R 25/24; H04W 4/04; G05D 1/00; G06Q 50/30

(52) U.S. Cl. CPC B60R 25/24; H04W 4/04; G05D 2201/0213; G06Q 50/30; G05D 1/0088

(57) ABSTRACT

Systems, methods, and vehicles for controlling access to a vehicle are provided. In one example embodiment, a method includes obtaining, by one or more computing devices on-board an autonomous vehicle, a first set of data indicative of a first matrix from one or more remote computing devices that are remote from the autonomous vehicle. The method includes obtaining a second set of data indicative of a second matrix via one or more image capture devices on-board the autonomous vehicle. The method includes determining whether the first matrix corresponds to the second matrix based at least in part on a comparison of the first matrix and the second matrix. The method includes providing one or more control command signals to one or more control systems of the autonomous vehicle to provide a user access to the autonomous vehicle when the first matrix corresponds to the second matrix.

### FIELD

The present disclosure relates generally to controlling access to an autonomous vehicle.

### BACKGROUND

An autonomous vehicle can perceive its surroundings by using various sensor apparatuses and determine its position on the basis of the information associated with its surroundings. This can allow an autonomous vehicle to navigate without human intervention and, in some cases, even omit the use of a human driver altogether. However, the lack of in-person human oversight can potentially reduce the vehicle's security. For instance, a person is unavailable to determine which individuals should be permitted access to the vehicle. While an autonomous vehicle may be monitored by a remote tracking system, such monitoring is reliant upon the availability of one or more communication network(s).

### SUMMARY

Aspects and advantages of embodiments of the present disclosure will be set forth in part in the following description, or may be learned from the description, or may be learned through practice of the embodiments.

One example aspect of the present disclosure is directed to a computer-implemented method of controlling access to a vehicle. The method includes obtaining, by one or more computing devices on-board an autonomous vehicle, a first set of data indicative of a first matrix. The first set of data indicative of the first matrix is obtained by the one or more computing devices on-board the autonomous vehicle from one or more remote computing devices that are remote from the autonomous vehicle. The method includes obtaining, by the one or more computing devices, a second set of data indicative of a second matrix. The second set of data indicative of the second matrix is obtained via one or more image capture devices on-board the autonomous vehicle. The method includes determining, by the one or more computing devices, whether the first matrix corresponds to the second matrix based at least in part on a comparison of the first matrix and the second matrix. The method includes providing, by the one or more computing devices, one or more control command signals to one or more control systems of the autonomous vehicle to provide a user access to the autonomous vehicle when the first matrix corresponds to the second matrix.

Another example aspect of the present disclosure is directed to a computing system for controlling access to a vehicle. The system includes one or more processors on-board an autonomous vehicle and one or more memory devices on-board the autonomous vehicle. The one or more memory devices store instructions that when executed by the one or more processors on-board the autonomous vehicle cause the one or more processors to perform operations. The operations include obtaining a first set of data indicative of a first matrix. The first set of data is provided to the autonomous vehicle from one or more remote computing devices that are remote from the autonomous vehicle. The operations include obtaining a second set of data indicative of a second matrix. The second set of data is obtained via one or more image capture devices on-board the vehicle. Each of the first and second matrices includes machine-readable information encoded in the respective matrix. At least one of the machine-readable information of the first matrix and the machine-readable information of the second matrix is indicative of a level of access to be provided for the vehicle. The method includes identifying one or more first portions of the first matrix and one or more second portions of the second matrix. The method includes determining whether the first matrix corresponds to the second matrix based at least in part on a comparison of one or more of the first portions and one or more of the second portions. The method includes providing one or more control command signals to one or more control systems of the vehicle to provide a user access to the vehicle in accordance with the level of access when the first matrix corresponds to the second matrix.

Yet another example aspect of the present disclosure is directed to an autonomous vehicle including one or more image capture devices, one or more processors on-board the autonomous vehicle and one or more memory devices on-board the autonomous vehicle. The one or more memory devices store instructions that when executed by the one or more processors cause the one or more processors to perform operations. The operations include obtaining, from one or more computing devices that are remote from the autonomous vehicle, a first set of data indicative of a first matrix. The operations include obtaining, via one or more of the image capture devices, a second set of data indicative of a second matrix. Each of the first and second matrices comprises machine-readable information encoded in the respective matrix. The operations include comparing the first matrix to the second matrix to determine a correspondence between the first matrix and the second matrix. The operations include determining a level of access for the user based at least in part on the correspondence between the first matrix and the second matrix. The operations include providing the user access to the autonomous vehicle in accordance with the level of access.

Other example aspects of the present disclosure are directed to systems, methods, apparatuses, tangible, non-transitory computer-readable media, user interfaces, memory devices, and vehicles for providing access to a vehicle.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts an example system for controlling access to a vehicle according to example embodiments of the present disclosure;

FIG. 2 depicts example matrices according to example embodiments of the present disclosure;

FIG. 3 depicts an example data set indicative of a level of access according to example embodiments of the present disclosure;

FIG. 4 depicts a flow diagram of an example method of controlling access to a vehicle according to example embodiments of the present disclosure;

FIG. 5 depicts a flow diagram of an example method of determining a correspondence between matrices according to example embodiments of the present disclosure;

FIG. 6 depicts a flow diagram of an example method of providing a user access to a vehicle according to example embodiments of the present disclosure; and

FIG. 7 depicts an example system according to example embodiments of the present disclosure.

### DETAILED DESCRIPTION

Reference now will be made in detail to embodiments, one or more example(s) of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to controlling user access to autonomous vehicles. A service provider can use a fleet of vehicles to provide a service to a plurality of users. The fleet can include, for example, autonomous vehicles that can drive, navigate, operate, etc. with minimal and/or no interaction from a human driver, as further described herein. The autonomous vehicles can provide the services of the service provider. The services can include, for example, transportation services (e.g., rideshare services), courier services, delivery services, etc. A customer of the service provider and/or a worker/entity that provides maintenance to the vehicle may wish to access one of the service vehicles (e.g., to travel in the vehicle, to repair the vehicle's engine). To help control vehicle access, a central operations system (e.g., a cloud-based server system) of the service provider can provide a first matrix (e.g., readable barcode, QR code, image) to the vehicle's computing system (e.g., for local storage). The operations system can send a second matrix to a user device associated with the customer and/or maintenance worker. The second matrix can be stored and/or shown on the user device (e.g., mobile phone) and/or printed on a physical medium (e.g., paper). The matrices may be sent at a time when one or more communication network(s) are available for communication with the operations system. However, upon arrival of the vehicle (e.g., for ridesharing, for maintenance at a service depot), the communications network(s) may not be available. Thus, the customer and/or maintenance worker can present the second matrix to be scanned by the vehicle's image capture devices (e.g., cameras). The vehicle's computing system can locally verify (e.g., on-board the vehicle) that the user is permitted to access the vehicle by comparing the first and second matrices. In the event that the matrices correspond to one another, the user can gain access to the vehicle accordingly. In this way, the vehicle's computing system can locally control user access to the autonomous vehicle, even when one or more communication network(s) are unavailable for such verification.

More particularly, an operations computing system of the service provider can receive, from a user, a request for access to an autonomous vehicle. This can include a service request to use one of the fleet vehicles for the provided services (e.g., rideshare) and/or a request to access a vehicle to provide maintenance (e.g., at a service depot). The user can be a user that has downloaded a software application associated with the service provider, a user that has made a service request with the service provider, a user that is a customer of the service provider, a user that has registered with (e.g., signed-up with, has an account with, has a profile with, has subscribed to) the service provider, etc. Moreover, the user can be an individual and/or entity that provides maintenance (e.g., engine maintenance) and/or other services (e.g., computer repair, data management) to one or more part(s) of the autonomous vehicle.

The user can be associated with a level of access for the vehicle. The level of access can be indicative of one or more condition(s) (e.g., limitations) on the service provided by the vehicle to the user and/or the parts of the vehicle that are accessible by the user. For instance, the level of access can identify how, when, and/or what parts of the vehicle the user can access. The level of access can vary based, at least in part, on the type of user. By way of example, for the user of a rideshare service, the level of access may allow the user to enter the vehicle, use its internal comfort controls (e.g., seat adjustment, AC/heating system), travel to a desired location, etc. but restrict access to the vehicle's engine. In some implementations, the level of access may permit or prevent a user from participating in a ride pool service. In some implementations, the level of access can be indicative of a geographic restriction on the service provided by the vehicle. For example, the level of access may permit a user to only use the vehicle for transportation services within the user's city limits. For a user providing maintenance work, the level of access may allow the user to access certain parts of the vehicle depending on the worker's level of expertise. For instance, the level of access associated with an engine mechanic can be limited to access only under the vehicle's hood. The level of access associated with a computer technician can allow the user to access the vehicle's on-board computing systems (e.g., autonomy systems, navigation systems, communications systems). The level of access can be a default setting, automatically determined by the operations system, set by the service provider, requested by the user, etc.

The operations computing system can generate one or more matrices associated with the level of access. A matrix can include a machine-readable matrix that is encoded with machine-readable information. The matrix can include, for example, a two-dimensional matrix, a barcode, an optical label, an arrangement of shapes, an arrangement of characters, a text string, an image (e.g., of the user), bio-informatics, and/or any other type of machine-readable matrices. At least one of the first matrix and the second matrix can be indicative of and/or otherwise associated with the level of access. For example, at least one of the first matrix and the second matrix can itself include information that is descriptive of the level of access for a user to access a vehicle. In some implementations, at least one of the matrices can provide information (e.g., a pointer, an identifier) that the vehicle's computing system can utilize to look up the level of access (e.g., in a locally stored reference table).

The matrices can also, or alternatively, be encoded with other information. For example, at least one of the matrices can be encoded with information that is indicative of a route and/or destination location to be used by the vehicle's navigation system when providing transportation services to a user. In some implementations, at least one of the matrices can be encoded with information that is indicative of a user's account and/or profile from which the vehicle's computing system can obtain information about the user (e.g., comfort settings, user rating). As further described herein, a matrix can include information indicative of a promotion (e.g., for a discounted ride to a particular restaurant) and/or be a multi-purpose two-dimensional matrix (e.g., with an airline ticket also encoded therein).

The operations computing system can send the matrices to the vehicle's computing system and a user device associated with the user. For example, the operations computing system can assign a vehicle to a user for rideshare services. The operations computing system can send data indicative of a first matrix to the vehicle's computing system over a communications network via one or more wireless signal connections. The vehicle's computing system can store, at least a portion of, the data locally. The operations computing system can send data indicative of a second matrix to the user device (e.g., mobile phone, desktop). As further described herein, in some implementations, the second matrix can be transferred from one user to another. The second matrix can be provided to the vehicle's computing system by a user, for instance, via one or more image capture devices(s) (e.g., cameras) that are configured to scan the second matrix. The image capture device(s) can also be those that are used by the vehicle to operate autonomously.

The vehicle's computing system can compare the first matrix to the second matrix to determine if the matrices correspond. For example, the vehicle's computing system can compare one or more machine-readable portion(s) of the first matrix (and/or the information encoded therein) to one or more machine-readable portion(s) of the second matrix (and/or the information encoded therein) to determine if the first matrix corresponds (e.g., is the same as, presents the same information as) the second matrix. In this way, the vehicle can verify that the correct user is presenting the second matrix even without the availability of certain communications networks. In the event that the matrices do not correspond, the vehicle's computing system can deny the user access to the vehicle, for example, by sending one or more access denial signals to maintain locked vehicle doors.

In the event that the matrices do correspond, the vehicle's computing system can provide the user access to the vehicle in accordance with the level of access. For example, the vehicle's computing system can determine the level of access for the user based, at least in part, on the first and/or second matrix (e.g., encoded information therein, using a reference table). The vehicle's computing system can determine one or more action(s) to be performed by the vehicle control systems based, at least in part, on the level of access. The vehicle control systems can be configured to control one or more aspect(s) of the vehicle. For example, the vehicle control systems can control one or more access point(s) of the vehicle. The access point(s) can include features such as the vehicle's doors, trunk, hood, fuel tank access, other mechanical access features that can be actuated between states (e.g., lock and unlocked states), etc. The action(s) can include, for example, changing the state of one or more of the vehicle access point(s) (e.g., from a locked state to an unlocked state).

The vehicle's computing system can provide one or more control command signal(s) to the vehicle control systems to perform the actions to provide the user access in accordance with the level of access. By way of example, for a user providing maintenance to the vehicle, the level of access may permit the user to access the vehicle's engine under the hood and to provide fuel to the vehicle's gas tank. When the vehicle's computing system determines that the matrices correspond, the vehicle can determine the level of access for the user and determine that the vehicle's hood and fuel access should be unlocked. The vehicle's computing system can provide one or more control command signal(s) to the control systems responsible for controlling these functions to provide the user access to the vehicle in accordance with this level of access. Accordingly, the systems and methods of the present disclosure can provide a customizable security system for an autonomous vehicle.

The systems and methods described herein may provide a number of technical effects and benefits. For instance, by using locally stored matrices, on-board computing hardware, and image capture devices to determine user access, the vehicle can avoid an overreliance on communication networks to remotely verify users and/or to track user location. This can allow the vehicle computing systems to save computational resources that may otherwise be used for boosting communication interfaces on-board the vehicle. The saved resources can be allocated to other functions of the vehicle computing systems, such as imaging, object detection, autonomous navigation, etc. Additionally, the systems and methods described herein allow users without a mobile user device (e.g., smart phone) to access the autonomous vehicle. This can reduce the need to outfit the autonomous vehicle with additional security hardware (e.g., such as exterior keypads, different cameras) that would consume valuable processing and memory resources.

The systems and methods of the present disclosure also provide an improvement to vehicle computing technology, such as autonomous vehicle computing technology. For instance, the methods and systems enable the vehicle technology to provide customized levels of user access by leveraging the capability of the hardware on-board the vehicle (e.g., image capture devices used for autonomous operations, local processors, memory devices). The autonomous vehicle can receive a first set of data indicative of a first matrix, receive a second set of data indicative of a second matrix from the user via one or more of the vehicle's image capture device(s), determine whether the first matrix corresponds to the second matrix, and provide one or more control command signal(s) to one or more control system(s) of the vehicle to provide the user access to the vehicle (e.g., in accordance with a level of access). In this way, the systems and methods of the present disclosure improve the vehicle's computing technology by enabling it to locally control user access and increase vehicle security.

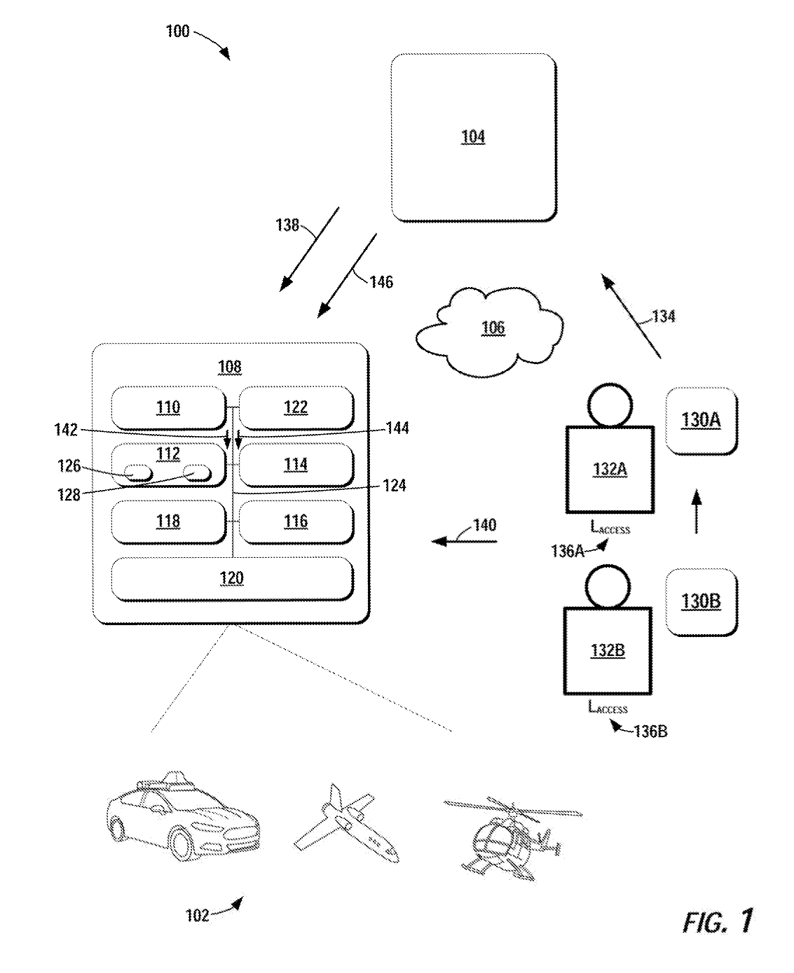

With reference now to the FIGS., example embodiments of the present disclosure will be discussed in further detail. FIG. 1 depicts an example system 100 according to example embodiments of the present disclosure. The system 100 can include a vehicle 102 and an operations computing system 104. The operations computing system 104 can be associated with a service provider that provides a service to a plurality of users via a fleet of vehicles that includes, for example, the vehicle 102. The service can include transportation services, courier services, delivery services, and/or other types of services.

The operations computing system 104 can include various components for performing various operations and functions. For example, the operations computing system 104 can include one or more computing device(s) that include one or more processor(s) and one or more memory device(s). The one or more memory device(s) can store instructions that when executed by the one or more processor(s) cause the one or more processor(s) to perform the operations and functions of the operations computing system 104. For example, the operations computing system 104 can be configured to monitor and communicate with the vehicle 102 (e.g., of the service provider) and/or its users 132A-B to coordinate a service provided by the vehicle 102 and/or to coordinate maintenance of the vehicle 102.

The operations computing system 104 can communicate with the vehicle 102 via one or more communications network(s) 106. The communications network(s) 106 can include various wired and/or wireless communication mechanisms (e.g., cellular, wireless, satellite, microwave, and radio frequency) and/or any desired network topology (or topologies). For example, the network(s) 106 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 102.

The vehicle 102 can be an automobile, an aircraft, and/or another type of vehicle. The vehicle 102 can be an autonomous vehicle that can drive, navigate, operate, etc. with minimal and/or no interaction from a human driver. The autonomous vehicle 102 can be configured to operate in one or more mode(s) such as, for example, a fully autonomous operational mode, a semi-autonomous operational mode, a park mode, a sleep mode, etc. A fully autonomous (e.g., self-driving) operational mode can be one in which the vehicle 102 can provide driving and navigational operation with minimal and/or no interaction from a human driver present in the vehicle. A semi-autonomous operational mode can be one in which the vehicle 102 can operate with some interaction from a human driver present in the vehicle. Park and/or sleep modes can be used between operational modes while the vehicle 102 waits to provide a subsequent service, recharges between operational modes, etc.

The vehicle 102 can include a vehicle computing system 108. The vehicle computing system 108 can include various components for performing various operations and functions. For example, the vehicle computing system 108 can include one or more computing device(s) 110 on-board the vehicle 102. The computing device(s) 110 can include one or more processor(s) and one or more memory device(s), each of which are on-board the vehicle 102. The one or more memory device(s) can store instructions that when executed by the one or more processor(s) cause the one or more processor(s) to perform operations and functions, such as those for controlling access to the vehicle 102, as described herein.

The computing device(s) 110 can implement, include, and/or otherwise be associated with various other systems of the vehicle 102. The computing device(s) 110 can be configured to communicate with these other systems of the vehicle 102. For instance, the computing device(s) 110 can be configured to communicate with one or more data acquisition system(s) 112, an autonomy system 114, one or more control system(s) 116, one or more human machine interface system(s) 118, other vehicle systems 120, and/or a communications system 122. The computing device(s) 110 can be configured to communicate with these systems via a network 124. The network 124 can include one or more data bus(es) (e.g., controller area network (CAN)), on-board diagnostics connector (e.g., OBD-II), and/or a combination of wired and/or wireless communication links. The computing device(s) 110 and/or the other systems can send and/or receive data, messages, signals, etc. amongst one another via the network 124.

The data acquisition systems 112 can include various devices configured to acquire data associated with the vehicle 102. This can include data associated with one or more of the vehicle's systems (e.g., health data), the vehicle's interior, the vehicle's exterior, the vehicle's surroundings, the vehicle users, etc. The data acquisition systems 112 can include, for example, one or more image capture device(s) 126. The image capture device(s) 126 can include one or more camera(s), light detection and ranging (or radar) device(s) (LIDAR systems), two-dimensional image capture devices, three-dimensional image capture devices, static image capture devices, dynamic (e.g., rotating) image capture devices, video capture devices (e.g., video recorders), lane detectors, scanners, optical readers, electric eyes, and/or other suitable types of image capture devices. The image capture device(s) 126 can be located in the interior and/or on the exterior of the vehicle 102. The image capture device(s) 126 can acquire image data to allow the vehicle 102 to implement one or more machine vision techniques (e.g., to detect objects in the surrounding environment).

Additionally, or alternatively, the data acquisition systems 112 can include one or more sensor(s) 128. The sensor(s) 128 can include motion sensors, pressure sensors, temperature sensors, humidity sensors, RADAR, sonar, radios, medium-range and long-range sensors (e.g., for obtaining information associated with the vehicle's surroundings), global positioning system (GPS) equipment, proximity sensors, and/or any other types of sensors for obtaining data associated with the vehicle 102 and/or relevant to the operation of the vehicle 102 (e.g., in an autonomous mode). The data acquired by the sensor(s) 128 can help detect other vehicles and/or objects, road conditions (e.g., curves, potholes, dips, bumps, changes in grade), measure a distance between the vehicle 102 and other vehicles and/or objects, etc. The sensor(s) 128 can also, or alternatively, include sensor(s) associated with one or more mechanical and/or electrical components of the vehicle. For example, one or more of the sensor(s) 128 can be configured to detect whether a vehicle door, trunk, gas cap, etc. is in an open or closed position.

The vehicle computing system 108 can also be configured to obtain map data. For instance, a computing device of the vehicle (e.g., within the autonomy system 114) can be configured to receive map data from one or more remote computing system(s) (e.g., associated with a geographic mapping service provider). The map data can include two-dimensional and/or three-dimensional geographic map data associated with the area in which the vehicle was, is, and/or will be travelling.

The autonomy system 114 can be configured to allow the vehicle 102 to operate in the autonomous mode. For instance, the autonomy system 114 can obtain the data associated with the vehicle 102 (e.g., acquired by the data acquisition systems 112). The autonomy system 114 can also obtain the map data. The autonomy system 114 can control various functions of the vehicle 102 based, at least in part, on the acquired data associated with the vehicle 102 and/or the map data to implement the autonomous mode. For example, the autonomy system 114 can include various models to perceive road features, signage, and/or objects, people, animals, etc. based on the data acquired by the data acquisition system(s) 112, map data, and/or other data. In some implementations, the autonomy system 114 can include machine-learned models that use the data acquired by the data acquisition system(s) 112, the map data, and/or other data to help operate the autonomous vehicle. Moreover, the acquired data can help detect other vehicles and/or objects, road conditions (e.g., curves, potholes, dips, bumps, changes in grade), measure a distance between the vehicle 102 and other vehicles or objects, etc. The autonomy system 114 can be configured to predict the position and/or movement (or lack thereof) of such elements (e.g., using one or more odometry techniques). The autonomy system 114 can be configured to plan the motion of the vehicle 102 based, at least in part, on such predictions. The autonomy system 114 can implement the planned motion to appropriately navigate the vehicle 102 with minimal or no human intervention. For example, the autonomy system can regulate vehicle speed, acceleration, deceleration, steering, and/or operation of other components to operate in an autonomous mode.

The one or more control system(s) 116 of the vehicle 102 can be configured to control one or more aspect(s) of the vehicle 102. For example, the control system(s) 116 can control one or more access point(s) of the vehicle 102. The access point(s) can include features such as the vehicle's door locks, trunk lock, hood lock, fuel tank access, latches, and/or other mechanical access features that can be adjusted between one or more state(s), position(s), location(s), etc. For example, the control system(s) 116 can be configured to control an access point (e.g., door lock) to adjust the access point between a first state (e.g., lock position) and a second state (e.g., unlocked position). Additionally, or alternatively, the control system(s) 116 can be configured to control one or more other electrical feature(s) of the vehicle 102 that can be adjusted between one or more state(s). For example, the control system(s) 116 can be configured to control one or more electrical feature(s) (e.g., AC system, interior lights, sound system, microphone) to adjust the feature between a first state (e.g., off, low) and a second state (e.g., on, high). In some implementations, to control the access point(s) and/or other electrical feature(s), the control system(s) 116 can send one or more signal(s) that define a state for the access point(s) and/or other electrical feature(s). The access point(s) and/or other electrical feature(s) can receive such signals and adjust according to the state defined in the signals.

The human machine interface system(s) 118 can be configured to allow interaction between a user (e.g., human) and the vehicle 102 (e.g., the vehicle computing system 108). The human machine interface system(s) 118 can include a variety of interfaces for the user to input and/or receive information from the vehicle computing system 108. For example, the human machine interface system(s) 118 can include a graphic user interface, direct manipulation interface, web-based user interface, touch user interface, attentive user interface, conversational and/or voice interfaces (e.g., via text messages, chatter robot), conversational interface agent, interactive voice response (IVR) system, gesture interface, holographic user interface, intelligent user interface (e.g., acting on models of the user), motion tracking interface, non-command user interface, OOUI, reflexive user interface, search interface, tangible user interface, task focused interface, text based interface, natural language interfaces, command line interface, zero-input interfaces, zooming user interfaces, and/or other types of interfaces. The human machine interface system(s) 118 can include one or more input device(s) (e.g., touchscreens, keypad, touchpad, knobs, buttons, sliders, switches, mouse, gyroscope, microphone, other hardware interfaces) and one or more output device(s) (e.g., display devices, speakers, lights) to receive and output data associated with the interfaces.

The other vehicle systems 120 can be configured to control and/or monitor other aspects of the vehicle 102. For example, the other vehicle systems 120 can include an on-board diagnostics systems, engine control unit, transmission control unit, memory devices, etc. The computing device(s) 110 can be configured to communicate with the other vehicle systems 120 to receive data and/or to send to one or more signals.

The communications system 122 can be configured to allow the vehicle computing system 108 (and its computing device(s) 110) to communicate with other computing devices. In some implementations, the vehicle computing system 108 can use the communications system 122 to communicate with one or more user device(s) 130A-B over the network(s) 106. In some implementations, the communications system 122 can allow the computing device(s) 110 to communicate with one or more on-board systems of the vehicle 102. The vehicle computing system 108 can use the communications system 122 to communicate with the operations computing system 104 over the network(s) 106 (e.g., via one or more wireless signal connections). The communications system 122 can include any suitable components for interfacing with one or more network(s), including for example, transmitters, receivers, ports, controllers, antennas, or other suitable components that can help facilitate communication with one or more remote computing device(s) (e.g., of the operations computing system 104) that are remote from the vehicle 102.

The operations computing system 104 can receive, from a user device 130A associated with a user 132A, data 134 indicative of a request for access to a vehicle. The request can include, for example, a service request to use one of the service provider's vehicles for the provided services (e.g., rideshare, courier) and/or a request to access a vehicle to provide maintenance (e.g., at a service depot). The user 132A can be a user that has downloaded a software application associated with the service provider, a user that has made a service request with the service provider, a user that is a customer of the service provider, a user that has registered with (e.g., signed-up with, has an account with, has a profile with, has subscribed to) the service provider, etc. Moreover, the user 132A can be an individual and/or entity that provides maintenance (e.g., engine maintenance) and/or other services (e.g., computer repair, data management) to one or more part(s) of a vehicle (e.g., 102).

The user 132A can be associated with a level of access 136A. The level of access 136A can be indicative of one or more condition(s) (e.g., authorizations, restrictions) on the user's use of a vehicle. For instance, this can include one or more condition(s) on the parts of a vehicle that are accessible by the user 132A. For instance, the level of access can identify how, when, and/or what parts of the vehicle 102 the user 132A can access. The level of access 136A can vary based, at least in part, on the type of user. By way of example, as a user of a rideshare service, the level of access 136A may allow the user 132A to enter the vehicle 102, use internal comfort controls (e.g., seat adjustment, AC/heating system) of the vehicle 102, use one or more of the human-machine interface system(s) 118, travel to a desired location, etc. The level of access 136A may, however, restrict the rideshare user from access the engine of the vehicle 102. For a user providing maintenance work, the level of access 136A may allow the user 132A to access certain parts of the vehicle 102 depending on the worker's level of expertise. For instance, the level of access 136A associated with an engine mechanic can limit the user 132A such that he/she can access only under the vehicle's hood. The level of access 136A associated with a computer technician can allow the user 132A to access the vehicle's on-board computing systems (e.g., autonomy systems, data acquisition systems, communications systems). The level of access 136A can be a default setting, automatically determined by the operations computing system 104, set by the service provider, requested by the user 132A, etc.

In some implementations, the level of access 136A can be indicative of a restriction on the service provided by a vehicle to the user 132A. For example, the level of access 136A can be indicative of a geographic restriction such that the user 132A can use the vehicle's services within a certain geographic region (e.g., neighborhood, city, state, country). Additionally, or alternatively, the level of access 136A can be indicative of other service restrictions such as, for example, a restriction on the amount of fuel used in providing a service to the user 132A, a restriction on the amount of time used in providing a service to the user 132A, and/or other restrictions.

In some implementations, the level of access 136A may be indicative of whether the user 132A is permitted to and/or prohibited from participating in a ride pool service. For example, in the event that a user rating (e.g., associated with the user's behavior) is low, the user 132A can be restricted from participating in a ride pool service with other users. Such a restriction can be indicated in a level of access associated with a user. This can prevent the exposure of other riders to the user's potentially poor and/or unsafe behavior.

In some implementations, the vehicle 102 can be associated with a level of access, irrespective of the individual user. For instance, the vehicle 102 can be associated with a level of access such that all users are permitted the same level of access to the vehicle 102. In some implementations, this can vary based, at least in part, on the type of user (e.g., service customer vs. maintenance worker).

The operations computing system 104 can be configured to generate one or more matrices associated with the level of access 136A. A matrix can be a machine-readable matrix that is encoded with machine-readable information. The matrix can include, for example, a two-dimensional matrix, a barcode, a Quick Response (QR) code, an optical label, an arrangement of shapes, an arrangement of characters, a text string, an image (e.g., of a user), information useable for bio-informatics techniques, and/or any other type of machine-readable matrices.

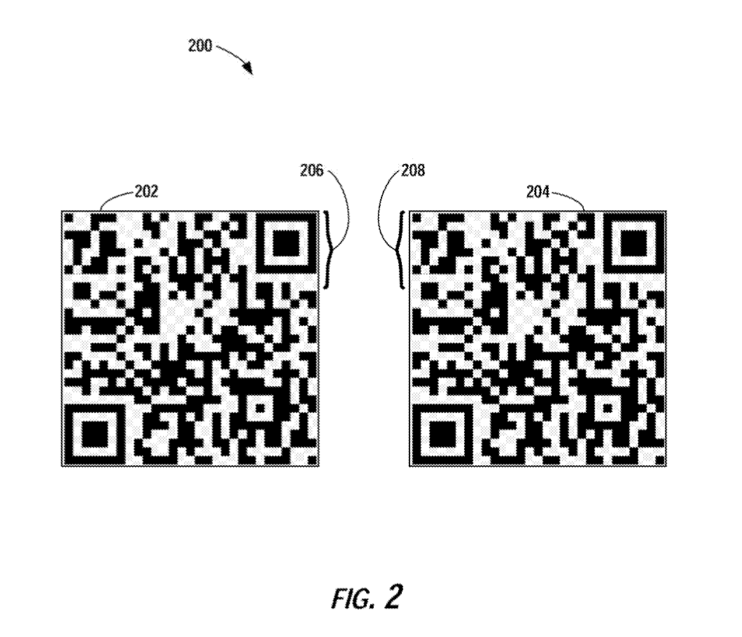

FIG. 2 depicts example matrices 200 according to example embodiments of the present disclosure. The operations computing system 104 (and/or other computing systems remote and/or on-board the vehicle 102) can generate a first matrix 202 and a second matrix 204. Each of the first and second matrices 202, 204 can include machine-readable information encoded in the respective matrix. For instance, at least one portion of the machine-readable information of the first matrix 202 and the machine-readable information of the second matrix 204 can be indicative of a level of access 136A (e.g., restrictions, authorizations) to be provided for the vehicle 102. In some implementations, a matrix (e.g., 202, 204) can be indicative of the level of access 136A by the matrix itself including information that is indicative of the level of access 136A for a user 132A to access a vehicle. In some implementations, a matrix can be indicative of the level of access 136A by providing a reference (e.g., identifier, key, pointer) that can be utilized to identify, look up, search for, find, etc. the level of access 136A (e.g., in a reference table).

Each of the first and second matrices 202, 204 can include portions that are indicative of machine-readable information. For example, the first matrix 202 can include one or more first portion(s) 206. The second matrix 204 can include one or more second portion(s) 208. Each of the portion(s) can present the same, similar, and/or distinct information as one or more other portion(s). For instance, a first portion 206 of the first matrix 202 can be the same as and/or present the same information as a second portion 208 of the second matrix 204 such that a computing system can verify that the first and second matrices correspond to one another.

Additionally, or alternatively, the first matrix 202 and/or the second matrix 204 can be encoded with other information (e.g., machine-readable information). For example, at least one of the first and second portions 206, 208 of the matrices can be encoded with information that is indicative of a route and/or destination location to be used by the vehicle's navigation system when providing transportation services to a user 132A. In some implementations, at least one of the first and/or second portions 206, 208 can be encoded with information that is indicative of a user's account and/or profile from which the vehicle computing system 108 can obtain information about the user 132A (e.g., comfort settings, user rating). In the event the vehicle 102 is being used for a courier service, one or more of the portion(s) 206, 208 of the matrices can be indicative of one or more characteristics associated with the item to be couriered (e.g., the type of package to be couriered by the vehicle 102, its destination location, the delivery timeframe).

In some implementations, at least one of the first matrix 202 and the second matrix 204 can be indicative of a promotion for the user 132A. By way of example, a restaurant may arrange a promotion with the service provider such that a user 132A of the service provider's transportation services is available to obtain a discount to travel to the restaurant via the service provider's vehicles (e.g., vehicle 102). To implement the promotion, the operations computing system 104 (and/or another computing system of the service provider) can generate one or more matrices (e.g., 202, 204) that is indicative of the travel discount to the restaurant's location. Information indicative of the discount can be encoded, for instance, in the machine-readable information of at least a portion (e.g., 206, 208) of the one or more matrices (e.g., 202, 204).

In some implementations, at least one of the first and second matrices 202, 204 can be included in a multi-purpose matrix. For instance, one or more of the first portion(s) 206 and/or the second portion(s) 208 of the first and/or second matrices 202, 204 can be used for a purpose that is not associated with a vehicle of the service provider. By way of example, one or more of the first portion(s) 206 and/or the second portion(s) 208 can include machine-readable information indicative of an airline ticket, hotel room access, event ticket, etc. The vehicle 102 can be arranged to provide a transportation service for the user 132A to arrive at a location when such machine-readable information can be used for its intended purpose.

Returning to FIG. 1, the operations computing system 104 can be configured to send the matrices 202, 204 to be used for controlling access to the vehicle 102. For instance, the computing device(s) 110 on-board the vehicle 102 can obtain a first set of data 138 indicative of the first matrix 202. The first set of data 138 can be provided to the vehicle 102 from one or more remote computing device(s) that are remote from the vehicle 102, such as the computing devices of the operations computing system 104. The computing device(s) 110 on-board the vehicle 102 can obtain the first set of data 138 before, during, and/or after the operations computing system 104 assigns the vehicle 102 to the user 132A (e.g., for a service request, for maintenance). The operations computing system 104 can provide the first set of data 138 via the network(s) 106, which can be available, for instance, at the time the vehicle 102 is assigned to the user 132A. The computing device(s) 110 can store, at least a portion, of the first set of data 138 indicative of the first matrix 202 in one or more memory device(s) on-board the vehicle 102.

The computing device(s) 110 on-board the vehicle 102 can also obtain a second set of data 140 indicative of the second matrix 204. For instance, the operations computing system 104 can send the second matrix 204 to the user device 130A (e.g., mobile phone, tablet, laptop, desktop) associated with the user 132A. The user device 130A can obtain the second matrix 204 before, during, and/or after the operations computing system 104 assigns the vehicle 102 to the user 132A. The second matrix 204 can be stored and shown on a display device of the user device 132A and/or printed onto a physical medium (e.g., paper). Upon arrival of the vehicle 102 to the user's location, the user 132A can present the second matrix (e.g., shown on the user device 130A, shown on the paper) to the vehicle 102. The computing device(s) 110 can obtain the second set of data 140 indicative of the second matrix 204 via one or more of the image capture device(s) 126 on-board the vehicle 102, such as one or more camera(s). The second matrix can be readable by the one or more image capture device(s) 128 of the vehicle 102. The one or more image capture device(s) 126, used to obtain the second set of data 140 indicative of the second matrix 204, can also be configured to gather image data for the vehicle 102 to operate in an autonomous mode. In this way, the same image capture device(s) 126 (e.g., camera(s)) used for detecting nearby vehicles, bicycles, pedestrians, objects, etc. during autonomous operation can be used to grant access to the vehicle 102.

In some implementations, the second matrix 204 can be transferred to the user 132A from a different user 132B. For instance, the different user 132B can make a request for transportation services from the service provider. The operations computing system 104 can send the second matrix 204 to a user device 130B associated with the different user 132B before, during, and/or after the vehicle 102 is assigned to the user's request. The different user 132B may transfer the second matrix 204 to the user device 130A by sending data indicative of the second matrix 204 to the user device 130A of the user 132A. A level of access 136A for the user 132A can be the same, similar, and/or different than a level of access 136B for the different user 132B. In some implementations, the operations computing system 104 can be notified (e.g., by one or more of the user device(s) 130A-B) that a transfer will, is, and/or has occurred. The operations computing system 104 can indicate the transfer in its records and/or note that the user 132A is now associated with the second matrix 204. In some implementations, the operations computing system 104 can send a notification to the computing device(s) 110 on-board the vehicle indicating that the transfer will, is, and/or has taken place along with any updated information.

The computing device(s) 110 on-board the vehicle 102 can compare the first matrix 202 to the second matrix 204 to determine a correspondence between the first matrix 202 and the second matrix 204. The first matrix 202 can be considered to correspond to the second matrix 204 such that a computing system can compare the matrices and verify that the matrices are related. For instance, the first matrix 202 can correspond to the second matrix 204 when at least a portion of or the entirety of the first matrix 202 is the same as, or presents the same information as, the second matrix 204. To determine such correspondence, the computing device(s) 110 can identify one or more first portion(s) 206 of the first matrix 202 and one or more second portion(s) 208 of the second matrix 204. The computing device(s) 110 can determine whether the first matrix 202 corresponds to the second matrix 204 based, at least in part, on a comparison of one or more of the first portion(s) 206 and one or more of the second portion(s) 208.

In some implementations, the computing device(s) 110 can determine whether the first and second matrices 202, 204 correspond using one or more encryption techniques. For example, the first and second matrices 202, 204 can be encrypted matrices (e.g., encrypted bar codes). The first matrix 202 and/or the second matrix 204 can be associated with a digital signature scheme that can be validated, a symmetric algorithm, an asymmetric algorithm, a combination of private and/or public keys, and/or other encryption techniques to further secure the matrices. In some implementations, the systems can incorporate one or more other securing feature(s) (e.g., whitelist, blacklist) for determining whether the matrices correspond and/or whether a user should be provided access. The computing device(s) 110 can analyze the matrices 202, 204 to determine any associated encryption techniques, validate any such signatures, keys, etc., and/or apply any other security features to determine that the first and second matrices 202, 204 correspond to one another.

In the event that the matrices do not correspond, the computing device(s) 110 on-board the vehicle 102 can deny the user 132A access to the vehicle 102. In some implementations, the computing device(s) 110 can provide one or more access denial signal(s) 142 to one or more system(s) of the vehicle 102 when the first matrix 202 does not correspond to the second matrix 204. For example, the signal(s) can alert the control system(s) 116 to lock the access point(s) and/or to keep the access points in a locked state. Additionally, or alternatively, the signal(s) can cause a display device (e.g., that is visible by the user) to display a message and/or user interface indicating the denial of access to the user 132A.

In the event that the matrices do correspond, the computing device(s) 110 can provide the user 132A access to the vehicle 102. This can allow the user 132A to, for example, use the vehicle 102 for its services and/or provide maintenance to the vehicle 102, in accordance with a level of access 136A. The computing device(s) 110 can determine a level of access 136A for the user 132A based, at least in part, on the correspondence between the first matrix 202 and the second matrix 204. For example, at least one of the first matrix 202 and the second matrix 204 can include a reference that the computing device(s) 110 can use to look-up the level of access 136A to be provided to the user 132A for the vehicle 102.

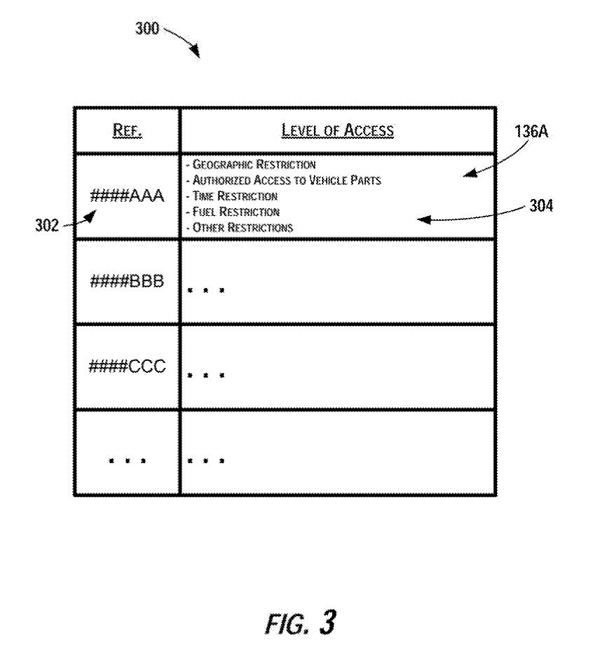

FIG. 3 depicts an example data set 300 indicative of a level of access 136A according to example embodiments of the present disclosure. The data set 300 can be formatted as and/or include a table, reference table, look-up table, file, array, record, list, tree, and/or other suitable data structures. The computing device(s) 110 can obtain the data set 300 from the operations computing system 104. In some implementations, the data set 300 can be sent at a time similar to that of the first set of data 138. The data set 300 can be stored locally so that the on-board computing device(s) 110 need not use the network(s) 106 to access the data set 300.

To determine the level of access, the computing device(s) 110 can parse at least one of the first matrix 202 and/or the second matrix 204 to identify a reference 302 associated with the level of access 136A. As indicated above, in some implementations, the level of access 136 can be indicative of one or more condition(s) 304 associated with, at least one of, a service provided by the vehicle 102 to the user 132A and one or more part(s) of the vehicle 102 that are accessible by the user 132A. The computing device(s) 110 can identify the one or more condition(s) 304 set forth by the level of access 136A based, at least in part, on the reference 302. As indicated above, the condition(s) 304 can include conditions on the service provided by the vehicle, the parts of the vehicle the user is authorized to access, a geographic restriction, etc. By way of example, the level of access 136A for a user of a rideshare service, may allow the user to enter the vehicle, use its internal AC/heating system, and travel to a desired location within the user's current city. The computing device(s) 110 can use the reference 302 to identify this level of access 136A for the user 132A in the data set 300.

In some implementations, the level of access 136A can be specific to a user 132A. For instance, the level of access 136A can be specifically associated with the user 132A for which the second matrix 204 was generated. In some implementations, the level of access 136A can be associated with a particular matrix (e.g., the second matrix 204) such that whichever user presents the matrix for use, the level of access 136A will be applied for that user.

Returning to FIG. 1, to provide the user 132A with the appropriate level of access to the vehicle 102, the computing device(s) 110 can determine one or more action(s) to be performed by the vehicle systems. For instance, as further described herein, the computing device(s) 110 can determine one or more action(s) to be performed by the one or more control system(s) 116 of the vehicle 102 based, at least in part, on the level of access 136A. For example, as indicated above, the one or more control system(s) 116 of the vehicle 102 can control one or more vehicle access point(s). The one or more action(s) can include changing the state of one or more of the vehicle access point(s). The computing system(s) 110 can provide one or more control command signal(s) 144 to the one or more control system(s) 116 of the vehicle 102 to perform the one or more action(s) to change the state of one or more of the vehicle access point(s). By way of example, based on the level of access 136A for a rideshare user, the computing device(s) 110 can determine to unlock the vehicle doors, enable user control of the AC/heating system, and enable navigation to the user's desired location. The computing device(s) 110 can provide one or more control command signal(s) to the control system(s) 116 (e.g., door control, AC control, navigation system) responsible for controlling these functions to implement such actions. The command signal(s) can also define the geographic restriction such that a use may not change his/her destination to one that is unauthorized. Accordingly, the computing device(s) 110 can provide one or more control command signal(s) 144 to one or more control system(s) 116 of the vehicle 102 to provide the user 132A access to the vehicle 102 in accordance with the level of access 136A, when the first matrix 202 corresponds to the second matrix 204.

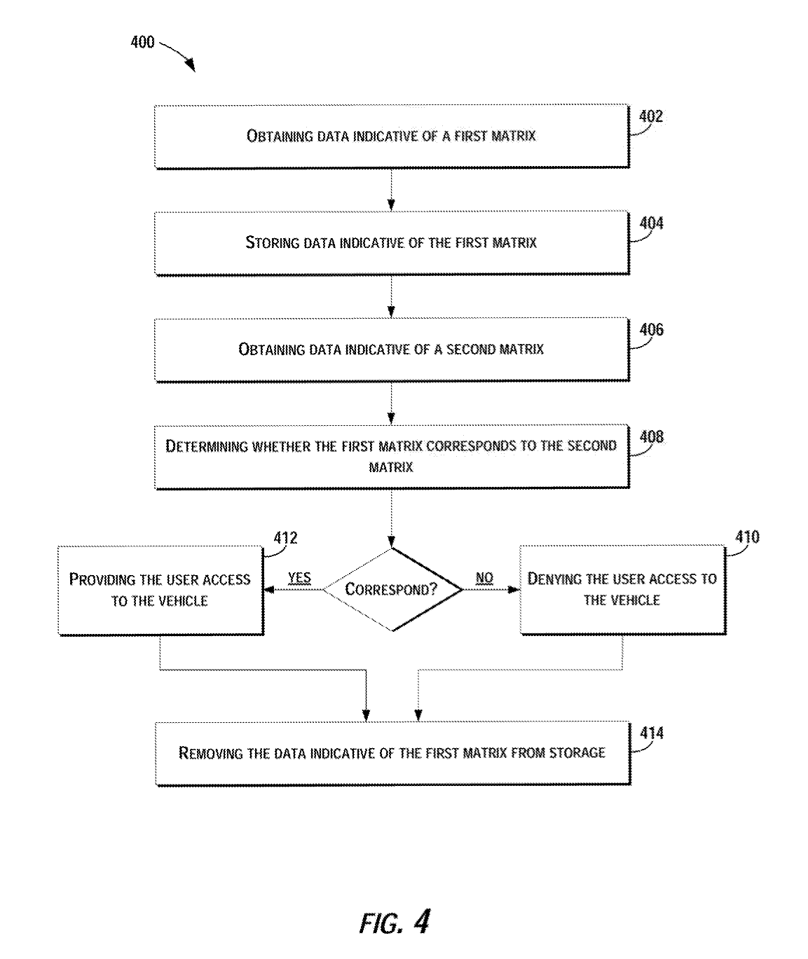

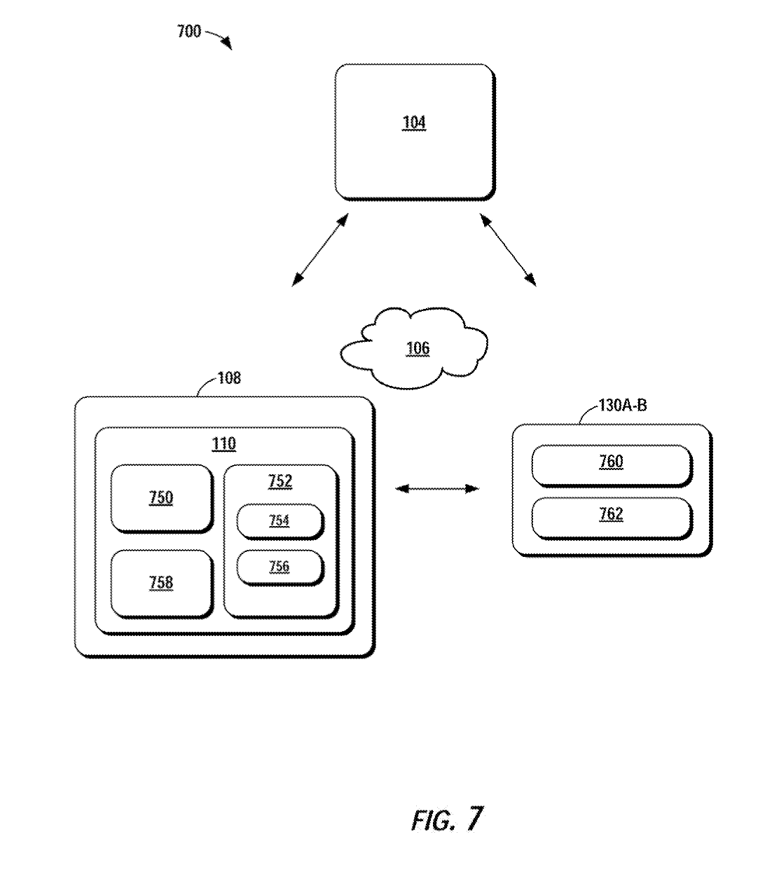

FIG. 4 depicts a flow diagram of an example method 400 of controlling access to a vehicle according to example embodiments of the present disclosure. One or more portion(s) of method 400 can be implemented by one or more computing device(s) such as, for example, the computing device(s) 110 shown in FIGS. 1 and 7. Moreover, one or more portion(s) of the method 400 can be implemented as an algorithm on the hardware components of the device(s) described herein (e.g., as in FIGS. 1 and 7) to, for example, control access to a vehicle. FIG. 4 depicts elements performed in a particular order for purposes of illustration and discussion. Those of ordinary skill in the art, using the disclosures provided herein, will understand that the elements of any of the methods (e.g., of FIGS. 4-6) discussed herein can be adapted, rearranged, expanded, omitted, and/or modified in various ways without deviating from the scope of the present disclosure.

At (402), the method 400 can include obtaining data indicative of a first matrix. For instance, the computing device(s) 110 on-board a vehicle 102 (e.g., an autonomous vehicle) can obtain a first set of data 138 indicative of a first matrix 202. The first set of data 138 indicative of the first matrix 202 can be obtained by the one or more computing device(s) 110 on-board the vehicle 102 from one or more remote computing devices that are remote from the vehicle 102.

By way of example, a user 132A can request (e.g., via a user device 130A) that a service provider generate a matrix for the user 132A (and/or a different user 132B) to access a vehicle 102 immediately, soon thereafter, sometime later in the future, etc. The user 132A may desire to access (and/or for a different user 132B to access) the vehicle 102 for a service provided by the vehicle 102 (e.g., while in an autonomous mode), to provide maintenance to the vehicle 102, and/or for another reason.

The service provider's operations computing system 104 (e.g., that is remote from the vehicle) can generate a first matrix 202 and a second matrix 204 to allow the user 132A to access the vehicle 102 for a service, maintenance, etc. Each of the first and second matrices 202, 204 can include machine-readable information encoded in, for example, at least one of a barcode and an image. The operations computing system 104 can provide a first set of data 138 indicative of the first matrix 202 to the computing device(s) 110 on-board the vehicle 102. The computing device(s) 110 can store, at least a portion, of the first set of data 138 indicative of the first matrix 202 in one or more memory device(s) on-board the vehicle 102, at (404). The operations computing system 104 can also provide data indicative of a second matrix 204 to one or more user device(s) 130A-B associated with a user 132A (e.g., that requested the matrix, service, maintenance) and/or a different user 132B.

At (406), the method 400 can include obtaining data indicative of a second matrix. The computing device(s) 110 can obtain a second set of data 140 indicative of the second matrix 204. The second set of data 140 indicative of the second matrix 204 can be obtained via one or more image capture device(s) 126 on-board the vehicle 102. For example, at least a portion of the second set of data 140 indicative of the second matrix 204 can be provided by the operations computing system 104 to a user device 130A (e.g., desktop computer, mobile phone) associated with a user 132A. When the user 132A desires to use the transportation services of the vehicle 102 and/or to provide maintenance to the vehicle 102 (e.g., at a service depot), the user 132A can print the second matrix onto a physical medium (e.g., a badge) and/or display the second matrix 204 on a display device of the user device 130A. The user 132A can present the second matrix 204 (e.g., via the badge, user device) within the field of view of one or more image capture device(s) 126 (e.g., camera(s)) of the vehicle 102. These can be one or more of the image capture device(s) 126 that acquire data (e.g., image data) to be provided to the autonomy system 114 of the vehicle 102 (e.g., for operating the vehicle 102 in an autonomous mode). The computing device(s) 110 can obtain the second set of data 140 associated with the second matrix 204 via a captured image, scan, etc. of the second matrix 204 via the image capture device(s) 126. This can be done, even when one or more communication network(s) (e.g., 106) associated with at least one of the vehicle 102 and the user device 130A are not available for communication. The vehicle's on-board computing device(s) 110 can locally control access to the vehicle 102, even if one or more of the network(s) 106 are unavailable, because, at least a portion of the first set of data 138 indicative of the first matrix 202 is stored on-board the vehicle 102 and the second set of data 140 indicative of the second matrix 204 is obtain via on-board image capture device(s) 126.

At (408), the method 400 can include determining whether the first matrix corresponds to the second matrix. The computing device(s) 110 can determine whether the first matrix 202 corresponds to the second matrix 204 based, at least in part, on a comparison of the first matrix 202 and the second matrix 204.

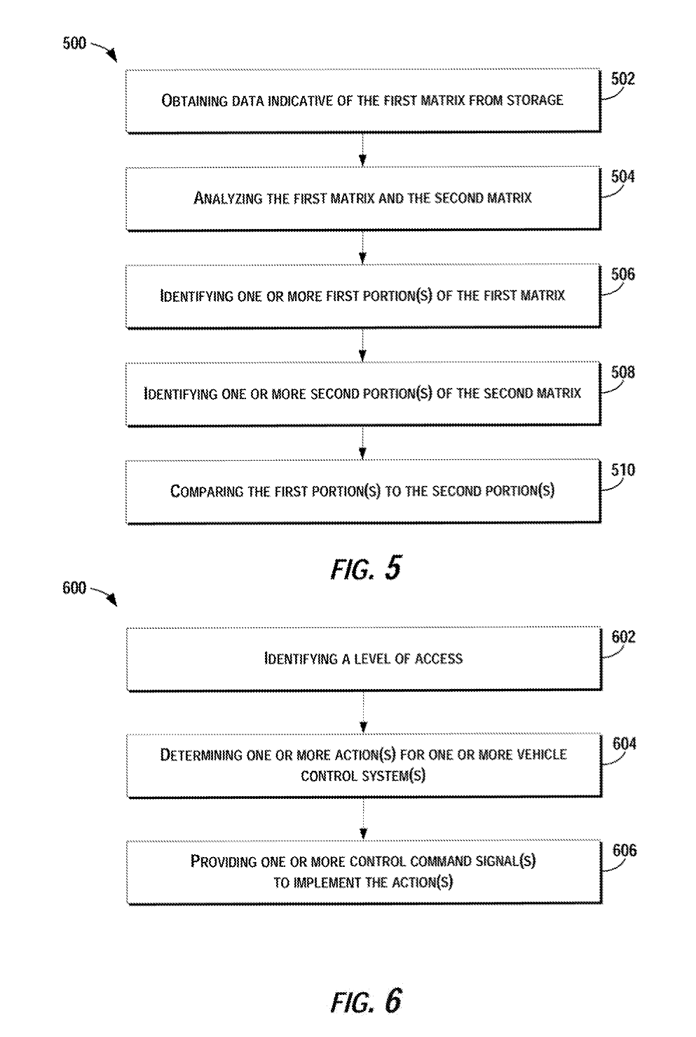

For example, FIG. 5 depicts a flow diagram of an example method 500 of determining a correspondence between matrices according to example embodiments of the present disclosure. One or more portion(s) of method 500 can be implemented by one or more computing device(s) such as, for example, the computing device(s) 110 shown in FIGS. 1 and 7. One or more portion(s) of the method 500 can be implemented as an algorithm on the hardware components of the device(s) described herein (e.g., as in FIG. 7). Moreover, one or more portion(s) of the method 500 can be implemented with one or more portion(s) of the method 400.

At (502), the method 500 can include obtaining data indicative of the first matrix from storage. For instance, the computing device(s) 110 can obtain, at least a portion of, the first set of data 138 from one or more memory device(s) on-board the vehicle 102. The computing device(s) 110 can analyze the first matrix 202 and/or the second matrix 204, at (504). For instance, the computing device(s) 110 can read, scan, etc. the first matrix 202 and/or the second matrix 204 to identify the machine-readable information encoded in the first matrix 202 and/or the second matrix 204.

At (506) and (508), the method 500 can include identifying one or more portion(s) of the first and second matrices, respectively. For instance, the computing device(s) 110 can identify one or more first machine-readable portion(s) 206 of the first matrix 202 (e.g., retrieved from local memory). The computing device(s) 110 can identify one or more second machine-readable portion(s) 208 of the second matrix 204, at (508).

In some implementations, different portions of the matrices can present different information. The computing device(s) 110 can identify one or more machine-readable portion(s) 206, 208 that are intended to be compared with another matrix (e.g., for verification), one or more machine-readable portion(s) 206, 208 indicative of a level of access, one or more machine-readable portion(s) 206, 208 indicative of a navigation route, one or more machine-readable portion(s) 206, 208 indicative of a user rating, account, profile, etc. and/or one or more machine-readable portion(s) encoded with other information.

At (510), the method 500 can include comparing the first portion(s) of the first matrix to the second portion(s) of the second matrix. For instance, the computing device(s) 110 can compare one or more of the first machine-readable portion(s) 206 to one or more of the second machine-readable portion(s) 208 to determine whether one or more of the first portion(s) 206 correspond to one or more of the second portion(s) 208. In some implementations, the computing device(s) 110 can determine that the first and second matrices 202, 204 correspond to one another when at least one of the first portion(s) 206 corresponds to at least one of the second portion(s) 208. In some implementations, the computing device(s) 110 can determine that the first and second matrices 202, 204 correspond to one another when more than one of the first portion(s) 206 correspond to more than one the second portion(s) 208. In some implementations, the computing device(s) 110 can determine that the first and second matrices 202, 204 correspond to one another when specific first portion(s) 206 of the first matrix 202 correspond to specific second portion(s) 208 of the second matrix 204. In some implementations, the computing device(s) 110 can determine that the first and second matrices 202, 204 correspond to one another when the entire first matrix 202 corresponds to the second matrix 204. As described above, in some implementations, the computing device(s) 110 can determine that the first and second matrices 202, 204 correspond to one another based on one or more encryption techniques.

Returning to FIG. 4, in the event that the first and second matrices do not correspond, at (410), the method 400 can include denying a user access to the vehicle. For instance, the computing device(s) 110 can provide one or more access denial signal(s) 142 to one or more system(s) of the vehicle 102 when the first matrix 202 does not correspond to the second matrix 204. The systems of the vehicle 102 can cause the vehicle 102 to enter into a secure state (e.g., locked, alarm set, emergency services contacted) based, at least in part, on one or more state(s) defined in the access denial signal(s) 142. This can occur when an unauthorized or incorrect user attempts to gain access to the vehicle 102, the user 132A is not authorized for the type of vehicle (e.g., high-end vehicle), when a matrix has expired, etc.

In the event that the first and second matrices do correspond, at (412), the method 400 can include providing a user access to the vehicle. For instance, the computing device(s) 110 can provide one or more control command signal(s) 144 to one or more control system(s) 116 of the vehicle 102 to provide a user 132A access to the vehicle 102 when the first matrix 202 corresponds to the second matrix 204. In some implementations, the computing device(s) 110 can provide one or more control command signal(s) 144 to the one or more control system(s) 116 of the vehicle 102 to provide the user 132A access to the vehicle 102 in accordance with a level of access 136A.

FIG. 6 depicts a flow diagram of an example method 600 of providing a user access to a vehicle according to example embodiments of the present disclosure. One or more portion(s) of method 600 can be implemented by one or more computing device(s) such as, for example, the computing device(s) 110 shown in FIGS. 1 and 7. One or more portion(s) of the method 600 can be implemented as an algorithm on the hardware components of the device(s) described herein (e.g., as in FIGS. 1 and 7). Moreover, one or more portion(s) of the method 600 can be implemented with one or more portion(s) of method 400.

At (602), the method 600 can include identifying a level of access for the user to access the vehicle. For instance, the computing device(s) 110 can identify a level of access 136A for the user 132A to access the vehicle 102 based, at least in part, on one or more of the first machine-readable portion(s) 206 (of the first matrix 202) corresponding to one or more of the second machine-readable portion(s) 208 (of the second matrix 204). As indicated herein, one or more of the machine-readable portion(s) 206, 208 can be encoded with information that is indicative of the level of access 136A. In some implementations, one or more of the machine-readable portion(s) 206, 208 can be encoded with a reference 302 that the computing device(s) 110 can use to identify the level of access 136A within data set 300 (e.g., a table).

As described herein, the level of access 136A can be indicative of one or more condition(s) associated with a service provided by the vehicle 102 to the user 132A. For example, the level of access 136A can include a geographic restriction of the user's use of the vehicle 102 for courier services (e.g., to within a certain region). Moreover, the level of access 136A can permit the user 132A to participate in a ride pool service provided by the vehicle 102. Additionally, or alternatively, the level of access 136A can permit the user 132A to access one or more part(s) of the vehicle 102 for maintenance.

At (604), the method 600 can include determining one or more action(s) for one or more vehicle control system(s). For instance, the computing device(s) 110 can determine one or more action(s) to be performed by the one or more control system(s) 116 of the vehicle based, at least in part, on the level of access 136A. For example, in some implementations, the computing device(s) 110 can analyze and translate the condition(s) set forth by the level of access 136A to create one or more action(s) to implement the condition(s). In some implementations, each of the condition(s) set forth by the level of access 136A can be associated with a reference that can be used by the computing device(s) 110 to look-up (e.g., in a look-up table) an action (and/or related control system) that is associated with that condition. For example, the level of access 136A may allow a user providing maintenance (e.g., cleaning) to the vehicle 102 to access only the vehicle's interior. The computing device(s) 110 can determine (e.g., via analysis and translation, look-up table) actions such as unlocking the vehicle's door to permit the user 132A access to the interior for cleaning.

At (606), the method 600 can include providing one or more control command signal(s) to implement the action(s). The computing device(s) 110 can provide the one or more control command signal(s) 144 to the one or more control system(s) 116 of the vehicle 102 to perform the one or more action(s) to allow the user 132A to access the vehicle 102 in accordance with the level of access 136A. For example, the computing device(s) 110 can send control command signal(s) 144 to the door lock control systems to change the vehicle door locks from a locked state to an unlock state to provide the user 132A access in accordance with the user's level of access 136A. The user 132A can, thus, access the vehicle interior for cleaning.

Additionally, or alternatively, the computing device(s) 110 can send one or more control command signal(s) 144 to implement other information encoded on the first and/or second matrix 202, 204. By way of example, the computing device(s) 110 can receive data 146 indicative of a service request by a user 132A for a transportation service provided by the vehicle 102. The vehicle 102 can provide the transportation service while operating in an autonomous mode. At least one of the first matrix 202 and the second matrix 204 can be indicative of a navigation route for the vehicle 102 to follow when providing the transportation service to the user 132A. The computing device(s) 110 can identify the navigation route encoded in the first and/or second matrix 202, 204. The computing device(s) 110 can send a control command to one or more vehicle systems (e.g., the autonomy system 114) to autonomously travel to a destination according to the navigation route. In this way, the computing device(s) 110 can navigate the vehicle 102 based, at least in part, on the navigation route.

Returning to FIG. 4, at (414), the method 400 can include removing the data indicative of the first matrix from storage. For instance, the computing device(s) 110 can remove any data from the first set of data 138 indicative of the first matrix 202 from storage in the on-board memory device(s) to save memory resources as well as to allow the first matrix 202 to be re-used at a later time.

FIG. 7 depicts an example system 700 according to example embodiments of the present disclosure. The system 700 can include the operations computing system 104, the vehicle computing system 108 (e.g., located on-board the vehicle 102), and one or more user device(s) 130A-B. The operations computing system 104, the vehicle computing system 108, and one or more user device(s) 130A-B can be configured to communicate via the one or more network(s) 106.

The vehicle computing system 108 can include the one or more computing device(s) 110. The computing device(s) 110 can include one or more processor(s) 750 on-board the vehicle 102 and one or more memory device(s) 752 on-board the vehicle 102. The one or more processor(s) 750 can be any suitable processing device such as a microprocessor, microcontroller, integrated circuit, an application specific integrated circuit (ASIC), a digital signal processor (DSP), a field-programmable gate array (FPGA), logic device, one or more central processing units (CPUs), graphics processing units (GPUs), processing units performing other specialized calculations, etc. The processor(s) can be a single processor or a plurality of processors that are operatively and/or selectively connected. The memory device(s) 752 can include one or more non-transitory computer-readable storage media, such as RAM, ROM, EEPROM, EPROM, flash memory devices, magnetic disks, etc., and/or combinations thereof.

The memory device(s) 752 can store information that can be accessed by the one or more processor(s) 750. For instance, the memory device(s) 752 on-board the vehicle can include computer-readable instructions 754 that can be executed by the one or more processor(s) 750. The instructions 754 can be software written in any suitable programming language or can be implemented in hardware. Additionally, or alternatively, the instructions 754 can be executed in logically and/or virtually separate threads on processor(s) 508A. The instructions 754 can be any set of instructions that when executed by the one or more processor(s) 750 cause the one or more processor(s) 750 to perform operations.

For example, the memory device(s) 752 on-board the vehicle 102 can store instructions that when executed by the one or more processor(s) 750 on-board the vehicle cause the one or more processor(s) 750 to perform operations such as any of the operations and functions of the computing device(s) 110 or for which the computing device(s) 110 are configured, as described herein, the operations for controlling access to a vehicle, determining a correspondence between matrices, and providing a user access to a vehicle (e.g., one or more portion(s) of methods 400, 500, 600), and/or any other operations or functions for controlling access to a vehicle, as described herein.

The one or more memory device(s) 752 can store data 756 that can be retrieved, manipulated, created, and/or stored by the one or more processor(s) 750. The data 756 can include, for instance, data associated with the vehicle 102, data acquired by the data acquisition system(s) 112, map data, data associated with a matrix, data associated with a level of access (e.g., data set 300), data associated with one or more action(s) and/or control command signals, data associated with users, and/or other data or information. The data 754 can be stored in one or more database(s). The one or more database(s) can be split up so that they are located in multiple locales on-board the vehicle 102. In some implementations, the computing device(s) 110 can obtain data from one or more memory device(s) that are remote from the vehicle 102.

The computing device(s) 110 can also include an interface 758 used to communicate with one or more other system(s) on-board the vehicle 102 (e.g., over the network(s) 124. The interface 758 can include any suitable components for interfacing with one or more network(s), including for example, transmitters, receivers, ports, controllers, antennas, or other suitable hardware and/or software.

The user device(s) 130A-B can be various types of computing devices. For example, the user device(s) 130A-B can include a phone, a smart phone, a tablet, a personal digital assistant (PDA), a laptop computer, a desktop computer, a computerized watch (e.g., a smart watch), computerized eyewear, computerized headwear, other types of wearable computing devices, a gaming system, a media player, an e-book reader, a television platform, an embedded computing device, and/or other types of mobile and/or non-mobile computing device.

The user device(s) 130A-B can include one or more input device(s) 760 and/or one or more output device(s) 762. The input device(s) 760 can include, for example, hardware for receiving information from a user, such as a touch screen, touch pad, mouse, data entry keys, speakers, a microphone suitable for voice recognition, etc. The output device(s) 762 can include hardware for providing content for display. For example, the output device(s) 762 can include a display device (e.g., display screen, CRT, LCD), which can include hardware for displaying a matrix for an image capture device 126 of the vehicle 102. Additionally, or alternatively, the output device(s) 762 can include a printing mechanism (e.g., printer). The user device(s) 130A-B can communicate with the printing mechanism via one or more wired and/or wireless connections to, for example, print a matrix on a physical medium (e.g., paper, badge) such that it is readable by an image capture device 126 of the vehicle 102.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein can be implemented using a single server or multiple servers working in combination. Databases and applications can be implemented on a single system or distributed across multiple systems. Distributed components can operate sequentially or in parallel.

Furthermore, computing tasks discussed herein as being performed at computing device(s) remote from the vehicle (e.g., the operations computing system and its associated computing device(s)) can instead be performed at the vehicle (e.g., via the vehicle computing system). For example, the vehicle computing system can be configured to generate matrices, communicate with users, etc. in the manner described above, without communicating with the operations computing system. Likewise, computing tasks discussed herein as being performed at the vehicle (e.g., via the vehicle computing system) can instead be performed by computing devices remote from the vehicle (e.g., the operations computing system and its associated computing device(s)). Such configurations can be implemented without deviating from the scope of the present disclosure.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1-20. (canceled)

21. A computer-implemented method of controlling access to a vehicle, comprising:
obtaining, by one or more computing devices on-board an autonomous vehicle, a first set of data indicative of a first matrix, wherein the first set of data indicative of the first matrix is obtained by the one or more computing devices on-board the autonomous vehicle from one or more remote computing devices that are remote from the autonomous vehicle;
obtaining, by the one or more computing devices, a second set of data indicative of a second matrix, wherein the second set of data indicative of the second matrix is obtained via one or more image capture devices on-board the autonomous vehicle, the one or more image capture devices are configured to gather image data associated with a surrounding environment of the autonomous vehicle, wherein the image data is used by the autonomous vehicle to perceive the surrounding environment of the autonomous vehicle and to plan a motion of the autonomous vehicle to autonomously navigate through the surrounding environment;
determining, by the one or more computing devices, whether the first matrix corresponds to the second matrix based at least in part on a comparison of the first matrix and the second matrix; and
providing, by the one or more computing devices, one or more control command signals to one or more control systems of the autonomous vehicle to provide a user access to the autonomous vehicle when the first matrix corresponds to the second matrix.

22. The computer-implemented method of claim 21, wherein each of the first and second matrices comprises machine-readable information encoded in at least one of a barcode and an image.

23. The computer-implemented method of claim 21, wherein providing, by the one or more computing devices, the one or more control command signals to the one or more control systems of the autonomous vehicle to provide the user access to the autonomous vehicle comprises:
providing, by the one or more computing devices, one or more control command signals to the one or more control systems of the autonomous vehicle to provide the user access to the autonomous vehicle in accordance with a level of access for the user to access the autonomous vehicle.

24. The computer-implemented method of claim 23, wherein the level of access is indicative of one or more conditions associated with a service provided by the autonomous vehicle to the user.

25. The computer-implemented method of claim 23, wherein the level of access permits the user to access one or more parts of the autonomous vehicle for maintenance.

26. The computer-implemented method of claim 21, wherein determining, by the one or more computing devices, whether the first matrix corresponds to the second matrix based at least in part on the comparison of the first matrix and the second matrix comprises:
identifying, by the one or more computing devices, one or more first machine-readable portions of the first matrix;
identifying, by the one or more computing devices, one or more second machine-readable portions of the second matrix; and
comparing, by the one or more computing devices, one or more of the first machine-readable portions to one or more of the second machine-readable portions to determine whether one or more of the first machine-readable portions correspond to one or more of the second machine-readable portions.

27. The computer-implemented method of claim 26, wherein providing, by the one or more computing devices, the one or more control command signals to the one or more control systems of the autonomous vehicle to provide the user access to the autonomous vehicle comprises:
identifying, by the one or more computing devices, a level of access for the user to access the autonomous vehicle based at least in part on one or more of the first machine-readable portions corresponding to one or more of the second machine-readable portions;
determining, by the one or more computing devices, one or more actions to be performed by the one or more control systems of the autonomous vehicle based at least in part on the level of access; and
providing, by the one or more computing devices, the one or more control command signals to the one or more control systems of the autonomous vehicle to perform the one or more actions to allow the user to access the autonomous vehicle in accordance with the level of access.

28. The computer-implemented method of claim 21, wherein the second set of data indicative of the second matrix is provided to a user device associated with the user, and wherein one or more communication networks associated with at least one of the autonomous vehicle and the user device are not available for communication.

29. The computer-implemented method of claim 21, further comprising:
storing, by the one or more computing devices, at least a portion of the first set of data indicative of the first matrix in one or more memory devices on-board the autonomous vehicle.

30. The computer-implemented method of claim 21, further comprising:
providing, by the one or more computing devices, one or more access denial signals to one or more systems of the autonomous vehicle when the first matrix does not correspond to the second matrix.

31. A computing system for controlling access to a vehicle, the system comprising:
one or more processors on-board an autonomous vehicle; and
one or more memory devices on-board the autonomous vehicle, the one or more memory devices storing instructions that when executed by the one or more processors on-board the autonomous vehicle cause the one or more processors to perform operations, the operations comprising:
obtaining a first set of data indicative of a first matrix, wherein the first set of data is provided to the autonomous vehicle from one or more remote computing devices that are remote from the autonomous vehicle;
obtaining a second set of data indicative of a second matrix, wherein the second set of data is obtained via one or more image capture devices on-board the vehicle, wherein the one or more image capture devices are configured to gather image data associated with a surrounding environment of the autonomous vehicle, wherein the image data is used by the autonomous vehicle to perceive the surrounding environment of the autonomous vehicle and to plan a motion of the autonomous vehicle to autonomously navigate through the surrounding environment;
wherein each of the first and second matrices comprise machine-readable information encoded in the respective matrix, and wherein at least one of the machine-readable information of the first matrix and the machine-readable information of the second matrix is indicative of a level of access to be provided for the vehicle;
identifying one or more first portions of the first matrix and one or more second portions of the second matrix;
determining whether the first matrix corresponds to the second matrix based at least in part on a comparison of one or more of the first portions and one or more of the second portions; and
providing one or more control command signals to one or more control systems of the vehicle to provide a user access to the vehicle in accordance with the level of access when the first matrix corresponds to the second matrix.

32. The computing system of claim 31, wherein the level of access is indicative of a condition associated with at least one of a service provided by the autonomous vehicle to the user and one or more portions of the autonomous vehicle that are accessible by the user.

33. The computing system of claim 31, wherein at least one of the first matrix and the second matrix is indicative of a promotion for the user.

34. The computing system of claim 31, wherein providing the one or more control command signals to the one or more control systems of the autonomous vehicle to provide the user access to the autonomous vehicle in accordance with the level of access comprises:
determining one or more actions to be performed by the one or more control systems of the autonomous vehicle based at least in part on the level of access, wherein the one or more control systems of the autonomous vehicle control one or more vehicle access points, and wherein the one or more actions comprise changing the state of one or more of the vehicle access points; and
providing the one or more control command signals to the one or more control systems of the autonomous vehicle to perform the one or more actions to change the state of one or more of the vehicle access points.

35. The computing system of claim 31, wherein the second matrix has been transferred to the user from a different user.

36. An autonomous vehicle, comprising:
one or more image capture devices;
one or more processors on-board the autonomous vehicle; and
one or more memory devices on-board the autonomous vehicle, the one or more memory devices storing instructions that when executed by the one or more processors cause the one or more processors to perform operations, the operations comprising:
obtaining, from one or more computing devices that are remote from the autonomous vehicle, a first set of data indicative of a first matrix;
obtaining, via one or more of the image capture devices, a second set of data indicative of a second matrix, wherein each of the first and second matrices comprise machine-readable information encoded in the respective matrix, wherein the one or more image capture devices are configured to gather image data associated with a surrounding environment of the autonomous vehicle, wherein the image data is used by the autonomous vehicle to perceive the surrounding environment of the autonomous vehicle and to plan a motion of the autonomous vehicle to autonomously navigate through the surrounding environment;
comparing the first matrix to the second matrix to determine a correspondence between the first matrix and the second matrix;
determining a level of access for the user based at least in part on the correspondence between the first matrix and the second matrix; and
providing the user access to the autonomous vehicle in accordance with the level of access.

37. The autonomous vehicle of claim 36, wherein the one or more image capture devices comprise one or more cameras, and wherein the second matrix is readable by the one or more cameras of the autonomous vehicle, and wherein the one or more cameras are configured to gather the image data associated with the surrounding environment of the autonomous vehicle.

38. The autonomous vehicle of claim 36, wherein the level of access permits the user to participate in a ride pool service provided by the vehicle.

39. The autonomous vehicle of claim 36, wherein the operations further comprise:
receiving data indicative of a service request by the user for a transportation service provided by the autonomous vehicle, and wherein at least one of the first matrix and the second matrix is indicative of a navigation route for the autonomous vehicle to follow when providing the transportation service; and
navigating the autonomous vehicle based at least in part on the navigation route.
